(19) United States
(12) Patent Application Publication
(10) Pub. No.: US 2021/0369548 A1
(43) Pub. Date: Dec. 2, 2021

(54) MASSAGE MECHANISM AND MASSAGE CONTROL DEVICE THEREOF, MASSAGE MACHINE AND WORKING METHOD OF MASSAGE MECHANISM

(71) Applicant: Aidepingfang Health Technology (Shanghai) Co., Ltd., Shanghai (CN)

(72) Inventor: YUICHI OKAMOTO, Shanghai (CN)

(21) Appl. No.: 17/399,769

(22) Filed: Aug. 11, 2021

Related U.S. Application Data
(63) Continuation of application No. PCT/CN2019/123003, filed on Dec. 4, 2019.

(51) Int. Cl. A61H 15/00

(52) U.S. Cl. CPC A61H 15/0078; A61H 2201/1676; A61H 2201/1463; A61H 2015/0028

(57) ABSTRACT

massage mechanism and a massage control device thereof, a massage machine and a working method of the massage mechanism are disclosed. The massage mechanism includes a transmission part that is rotatably connected to a first transmission arm, a second transmission arm connected to the first transmission arm, and a swing rod connected to the second transmission arm. Each of two ends of the swing rod is provided with a massage wheel. A swing mechanism is mounted on the second transmission arm, is in contact with the swing rod and is configured to drive the swing rod to swing. The swing rod is driven to swing back and forth through the swing mechanism; the massage wheels on the swing rod massage the person being treated in a “knocking” manner; and the speed of the speed reducer and the swing amplitude of the swing rod are adjustable.

### CROSS-REFERENCE TO RELATED APPLICATIONS

This application is a continuation of International Patent Application Number PCT/CN2019/123003, filed on Dec. 4, 2019, which claims the benefit and priority of Chinese Patent Application Number 201811192063.6, filed on Oct. 12, 2018 with China National Intellectual Property Administration, the disclosures of which are incorporated herein by reference in their entireties.

### TECHNICAL FIELD

The present disclosure relates to the technical field of massage equipment, and particularly relates to a massage mechanism and a massage control device thereof, a massage machine and a working method of the massage mechanism.

### BACKGROUND

As illustrated in FIG. 1 and FIG. 2, for a traditional massage machine 100, a massage mechanism of its massage control device 200 includes a transmission arm 104, a motor 101 mounted on the transmission arm 104, a speed reducer 102 and treatment wheels 103. The treatment wheels 103 are mounted in such a way of all being concentric with a power output shaft 105. The treatment wheels 103 rotate with the power output shaft 105 serving as a circle center and moves up and down on the back of a person being treated. A treatment path and speed are relatively flat and monotonous. The massage machine makes the person being treated feel ordinary and has a relatively poor treatment effect. Therefore, the present disclosure provides a massage mechanism that can realize multi-angle and multi-directional massage modes, so as to improve the comfort level of massage and achieve a better therapeutic effect.

### SUMMARY

The technical problem to be solved by the present disclosure is that all treatment wheels of an existing massage machine are concentric with a power output shaft, so that the massage effect is poor.

In order to solve the above-mentioned technical problem, the technical solution of the present disclosure provides a massage mechanism, including a transmission part that is rotatably connected with a first transmission arm, a second transmission arm connected with the first transmission arm, and a swing rod connected with the second transmission arm. Each of two ends of the swing rod is provided with a massage wheel. A swing mechanism is mounted on the second transmission arm, is in contact with the swing rod and drives the swing rod to swing.

Optionally, the swing mechanism includes a motor, a speed reducer connected with the motor, and a treatment wheel eccentrically mounted on the speed reducer. The treatment wheel is in contact with the swing rod.

Optionally, a motor shaft of the motor is connected with the input end of the speed reducer; the output end of the speed reducer is provided with a power output shaft; and the treatment wheel is eccentrically mounted on the power output shaft.

Optionally, a pericenter and an apocenter of the treatment wheel are respectively in contact with the swing rod cyclically in a rotation process; and the swing rod does an oscillating motion in the process of being in contact with the pericenter and the apocenter of the treatment wheel.

Optionally, the massage wheels are rotatably connected with the swing rod through rotating shafts.

Optionally, the swing amplitude of the swing rod ranges from 5 degrees to 15 degrees.

In order to solve the above-mentioned technical problems, the technical solution of the present disclosure further provides a massage control device including any of the foregoing massage mechanisms.

In order to solve the above-mentioned technical problems, the technical solution of the present disclosure further provides a massage machine including the foregoing massage control device.

In order to solve the above-mentioned technical problems, the technical solution of the present disclosure further provides a working method of any one of the massage mechanisms. The working method is as follows:

the motor is initiated to transmit power to the speed reducer; the power output shaft at the output end of the speed reducer rotates to drive the treatment wheel to do circumferentially eccentric rotation; the pericenter and the apocenter of the treatment wheel are respectively in contact with the swing rod cyclically in the rotation process; the swing rod does a reciprocating swing motion; and the massage wheels massage a person being treated.

The beneficial effects of the technical solutions of the present disclosure are as follows:

The present disclosure drives the swing rod to swing back and forth through the swing mechanism; the massage wheels on the swing rod massage the person being treated in a “knocking” manner; and the speed of the speed reducer and the swing amplitude of the swing rod are adjustable, so that various cooperation changes of the “knocking” manner can be realized, and different massage experiences and massage effects are brought to the person being treated.

### BRIEF DESCRIPTION OF THE DRAWINGS

FIG. 1 is a schematic structural diagram of a massage machine in the prior art;

FIG. 2 is a schematic structural diagram of a massage mechanism in the prior art;

FIG. 3 is a schematic structural diagram of a massage mechanism in Embodiment I of the present disclosure;

FIG. 4 is a schematic structural diagram of a swing mechanism in FIG. 3;

FIG. 5 is a schematic diagram of a state that an apocenter of a treatment wheel is in contact with a swing rod in Embodiment I of the present disclosure;

FIG. 6 is a schematic diagram of a state that a pericenter of a treatment wheel is in contact with a swing rod in Embodiment I of the present disclosure;

FIG. 7 is a schematic structural diagram of a massage mechanism in Embodiment II of the present disclosure;

FIG. 8 is an enlarged diagram in FIG. 7; and

FIG. 9 is a schematic structural diagram of a massage mechanism in Embodiment III of the present disclosure.

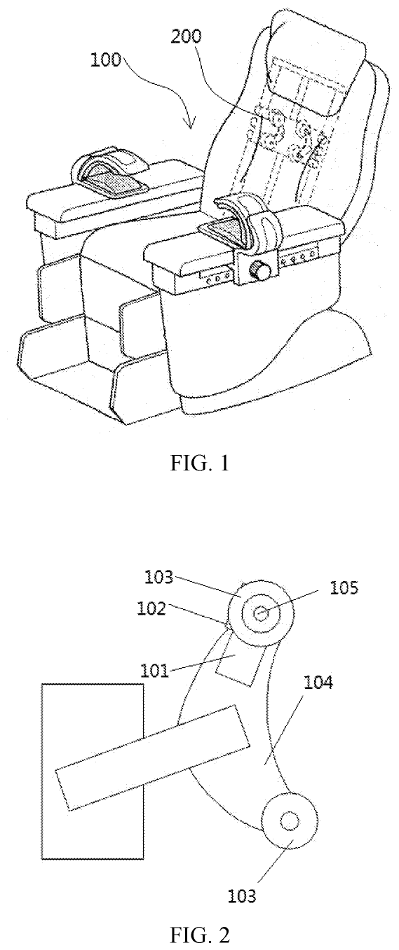

### DESCRIPTION OF THE EMBODIMENTS

The present disclosure is further described below in combination with the accompany drawings and specific embodiments that are not intended to limit the present disclosure.

In addition, the terms “first” and “second” are only for the purpose of description, and may not be understood as indicating or implying the relative importance or impliedly indicating the number of technical features indicated. Therefore, features defined by “first” and “second” can explicitly instruct or impliedly include one or more features. In the description of the present disclosure, unless expressly specified otherwise, the meaning of the “plurality” is two or more than two.

In the description of the present disclosure, unless otherwise explicitly specified and defined, the terms “installed”, “coupled” “connected” and “fixed” shall be understood broadly, and may be, for example, fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

### Embodiment I

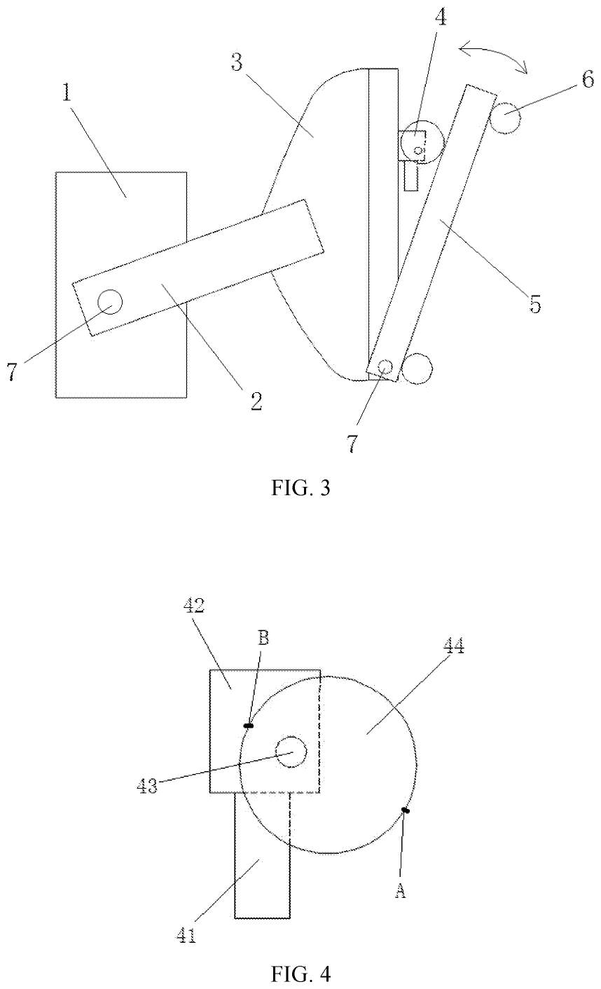

Referring to FIG. 3 and FIG. 4, a massage mechanism of one embodiment is illustrated. The massage mechanism includes a transmission part 1, wherein a first transmission arm 2 is connected with the transmission part 1 and does an arc rotation motion taking the transmission part 1 as a circle center (a speed reducer (not shown) is mounted on the transmission part 1, and the first transmission arm 2 is connected with the speed reducer and is driven by the speed reducer to move to realize the arc rotation motion taking the transmission part 1 as a circle center); a second transmission arm 3 connected with the first transmission arm 2, and a swing rod 5 connected with the second transmission arm 3. Each of two ends of the swing rod 5 is provided with a massage wheel 6. A swing mechanism 4 is mounted on the second transmission arm 3, is in contact with the swing rod 5 and drives the swing rod 5 to swing. The transmission part 1 and the first transmission arm 2 as well as the second transmission arm 3 and the swing rod 5 are rotatably connected through rotating shafts 7.

In the present embodiment, the swing mechanism 4 includes a motor 41, a speed reducer 42 connected with the motor 41, and a treatment wheel 44 eccentrically mounted on the speed reducer 42; and the treatment wheel 44 is in contact with the swing rod 5.

In the present embodiment, a motor shaft of the motor 41 is connected with the input end of the speed reducer 42; the output end of the speed reducer 42 is provided with a power output shaft 43; and the treatment wheel 44 is eccentrically mounted on the power output shaft 43.

In the present embodiment, a pericenter A and an apocenter B of the treatment wheel 44 are respectively in contact with the swing rod 5 cyclically in a rotation process; and the swing rod 5 does an oscillating motion (a motion direction is as illustrated by the arrow in FIG. 3) in the process of being in contact with the pericenter A and the apocenter B of the treatment wheel 44.

In the present embodiment, the massage wheels 6 are rotatably connected with the swing rod 5 through rotating shafts (not shown).

In the present embodiment, the swing amplitude of the swing rod ranges from 5 degrees to 15 degrees.

In the present embodiment, a massage control device is further provided, including any of the foregoing massage mechanisms.

In the present embodiment, a massage machine is further provided, including the above-mentioned massage control device.

The features and functions of the present disclosure are further illustrated by means of the following explanation.

The technical solution of the present embodiment further provides a working method of any one of the massage mechanisms. The working method is as follows:

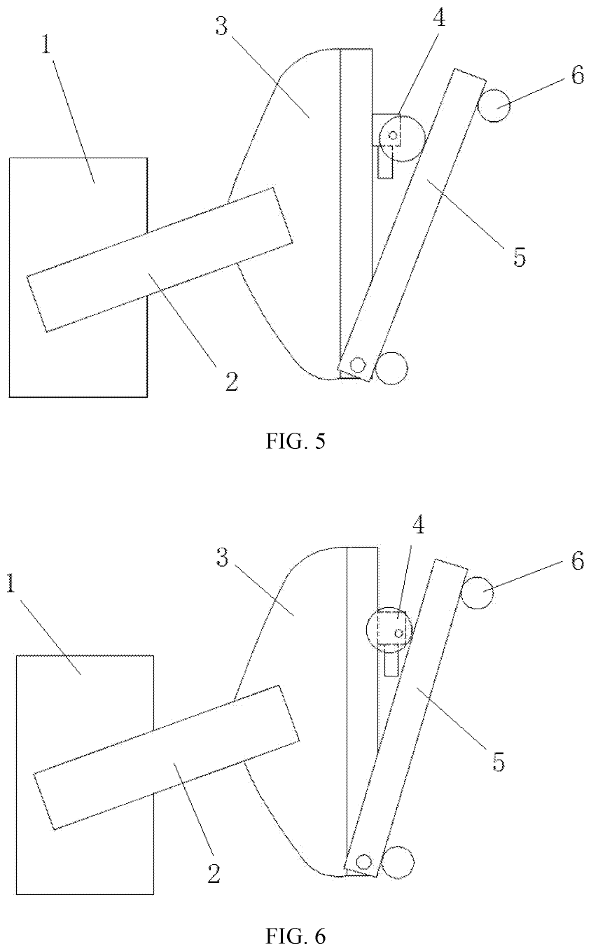

referring to FIG. 5 and FIG. 6, the person being treated lies on the massage machine; and the massage control device of the massage machine of the present embodiment presses against the back part of the person being treated. As illustrated in FIG. 3, those skilled in the art can understand that the right of the massage mechanism is the back part of the person being treated. After the person being treated lies down, the motor 41 is initiated to transmit power to the speed reducer 42; the power output shaft 43 at the output end of the speed reducer 42 rotates to drive the treatment wheel 44 to do circumferentially eccentric rotation; the pericenter A and the apocenter B of the treatment wheel 44 are respectively in contact with the swing rod 5 cyclically in the rotation process; the swing rod 5 does a reciprocating swing motion; and the massage wheels 6 massages the person being treated. In addition, the speed of the speed reducer 42 and the swing amplitude of the swing rod 5 can be finely adjusted to realize various cooperation changes of a “knocking” manner (for example, the rotating speed of the speed reducer is Xr/s, and the swing amplitude of the swing rod 5 is Y degrees, so that cooperation of various rotating speeds and swing amplitudes can be realized, wherein the swing amplitude of the swing rod 5 is specifically determined by the diameter of the treatment wheel 44) to bring different massage experiences and massage effects to the person being treated.

### Embodiment II

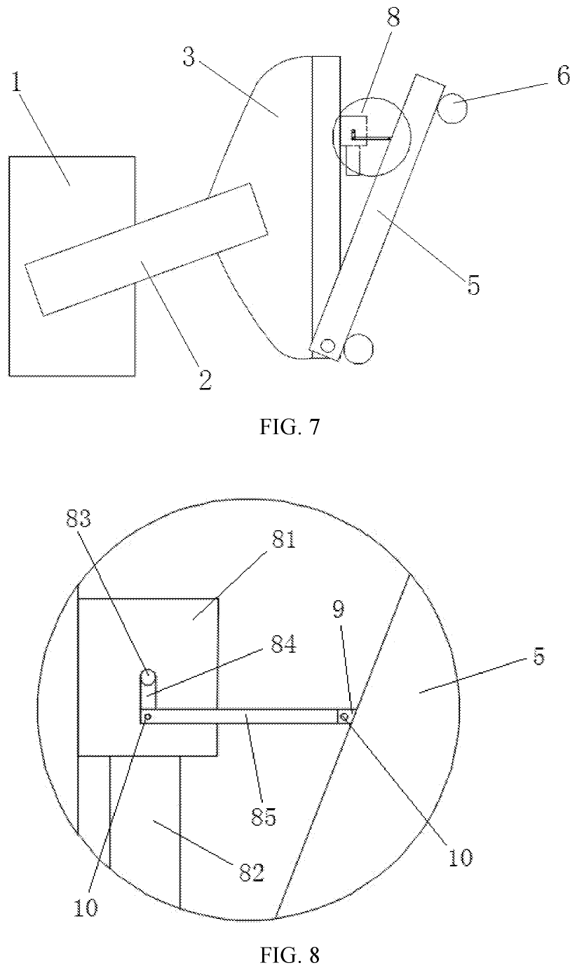

As illustrated in FIG. 7 and FIG. 8, in the present embodiment, the structure of the massage mechanism is basically the same as that in Embodiment I, but the only difference is that in the present embodiment, the swing mechanism 8 is of a connecting rod type structure, and includes a speed reducer 81, a motor 82, a power output shaft 83, a first connecting rod 84 and a second connecting rod 85; the motor 82 is connected with the speed reducer 81; the power output shaft 83 is located on the speed reducer 81; the first connecting rod 84 is connected with the power output shaft 83; the first connecting rod 84 is rotatably connected with the second connecting rod 85 through a rotating shaft 10; and the second connecting rod is rotatably connected with a lug plate 9 on the swing rod 5 through the rotating shaft 10. The working method of the massage mechanism of the present embodiment is that the motor 82 and the speed reducer 81 run; the power output shaft 83 drives the first connecting rod 84 to circumferentially rotate, and the first connecting rod 84 drives the second connecting rod 85 to circumferentially rotate at the same time; one end of the second connecting rod 85 connected with the first connecting rod 84 is actually driven back and forth by the first connecting rod 84, and the second connecting rod 85 moves left and right back and forth in a reciprocating manner relative to the other end connected with the first connecting rod 84 (i.e., the end connected with the swing rod 5), that is, the swing rod 5 is pulled by the second connecting rod 85 to swing in a back-and-forth movement manner, that is, the swing rod 5 in the present embodiment also realizes a back-and-forth swing function. The massage wheels 6 on the swing rod 5 massage the person being treated in a “knocking” manner. The speed of the speed reducer 81 and the swing amplitude of the swing rod 5 are adjustable, so that various cooperation changes of the “knocking” manner can be realized (for example, the rotating speed of the speed reducer is Xr/s, and the swing amplitude of the swing rod 5 is Y degrees, so that cooperation of various rotating speeds and swing amplitudes can be realized, wherein the swing amplitude of the swing rod 5 is specifically determined by a length between the first connecting rod 84 and the second connecting rod 85, that is, in the case that the length of the second connecting rod 85 does not change, if the length of the first connecting rod 84 is reduced, the swing amplitude is reduced; and if the length of the first connecting rod 84 is increased, the swing amplitude is increased), and different massage experiences and massage effects are brought to the person being treated.

Embodiment III

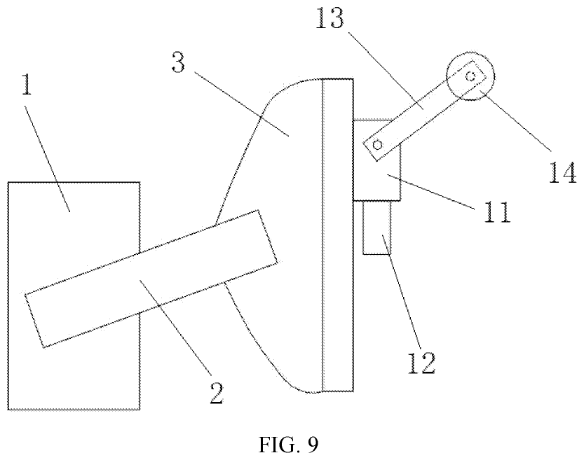

As illustrated in FIG. 9, in the present embodiment, the structure of the massage mechanism is basically the same as that in Embodiment I, but the only difference is that in the present embodiment, a swing relationship between the swing mechanism and the swing rod is canceled, and a motor 12, a speed reducer 11, a swing rod 13 and a massage wheel 14 are directly mounted on the second transmission arm 3; the speed reducer 11 directly drives the swing rod 13 to do reciprocating arc rotation, and the massage wheels 6 on the swing rod 5 massage the person being treated in a “knocking” manner; and the speed of the speed reducer is adjustable, so that various cooperation changes of the “knocking” manner can be realized, and different massage experiences and massage effects are brought to the person being treated.

The foregoing merely portrays some illustrative embodiments of the present disclosure, and do not therefore limit the implementations and protection scope of the present disclosure. Those skilled in the art should be able to appreciate that solutions obtained by equivalent replacements made by applying the specification of the present disclosure and the contents of the drawings and apparent changes shall all fall within the protection scope of the present disclosure.

What is claimed is:

1. A massage mechanism, comprising a transmission part that is rotatably connected to a first transmission arm, a second transmission arm connected to the first transmission arm, and a swing rod connected to the second transmission arm, wherein each of two ends of the swing rod is provided with a massage wheel; a swing mechanism is mounted on the second transmission arm, is in contact with the swing rod and is operative to drive the swing rod to swing.

2. The massage mechanism of claim 1, wherein the swing mechanism comprises a motor, a speed reducer connected to the motor, and a treatment wheel eccentrically mounted on the speed reducer; and wherein the treatment wheel is in contact with the swing rod.

3. The massage mechanism of claim 2, wherein a motor shaft of the motor is connected to an input end of the speed reducer; an output end of the speed reducer is provided with a power output shaft; and the treatment wheel is eccentrically mounted on the power output shaft.

4. The massage mechanism of claim 2, wherein a pericenter and an apocenter of the treatment wheel are respectively in contact with the swing rod cyclically in a rotation process; and the swing rod is configured to perform an oscillating motion in the process of being in contact with the pericenter and the apocenter of the treatment wheel.

5. The massage mechanism of claim 1, wherein the massage wheels are rotatably connected to the swing rod through rotating shafts.

6. The massage mechanism of claim 1, wherein a swing amplitude of the swing rod lies in the range of 5 degrees to 15 degrees.

7. A massage control device, comprising a massage mechanism, wherein the massage mechanism comprises a transmission part that is rotatably connected to a first transmission arm, a second transmission arm connected to the first transmission arm, and a swing rod connected to the second transmission arm, wherein each of two ends of the swing rod is provided with a massage wheel; a swing mechanism is mounted on the second transmission arm, is in contact with the swing rod and is operative to drive the swing rod to swing.

8. The massage control device of claim 7, wherein the swing mechanism comprises a motor, a speed reducer connected to the motor, and a treatment wheel eccentrically mounted on the speed reducer, and wherein the treatment wheel is in contact with the swing rod.

9. The massage control device of claim 8, wherein a motor shaft of the motor is connected to an input end of the speed reducer; an output end of the speed reducer is provided with a power output shaft; and the treatment wheel is eccentrically mounted on the power output shaft.

10. The massage control device of claim 8, wherein a pericenter and an apocenter of the treatment wheel are respectively in contact with the swing rod cyclically in a rotation process;
and the swing rod is configured to perform an oscillating motion in the process of being in contact with the pericenter and the apocenter of the treatment wheel.

11. The massage control device of claim 7, wherein the massage wheels are rotatably connected to the swing rod through rotating shafts.

12. The massage control device of claim 7, wherein a swing amplitude of the swing rod lies in the range of 5 degrees to 15 degrees.

13. A massage machine, comprising the massage control device of claim 7.

14. A massage machine, comprising the massage control device of claim 8.

15. A massage machine, comprising the massage control device of claim 9.

16. A massage machine, comprising the massage control device of claim 10.

17. A massage machine, comprising the massage control device of claim 11.

18. A massage machine, comprising the massage control device of claim 12.

19. A working method of the massage mechanism of claim 1, the working method comprising:
initiating the motor to transmit power to the speed reducer;
rotating, by the power output shaft at the output end of the speed reducer, and driving the treatment wheel to perform a circumferential eccentric rotation;
allowing the pericenter and the apocenter of the treatment wheel to be respectively in contact with the swing rod cyclically in the rotation process;
performing, by the swing rod, a reciprocating swing motion; and
massaging, by the massage wheels, a person being treated.
